(19) United States
(12) Patent Application Publication
(10) Pub. No.: US 2005/0118913 A1
(43) Pub. Date: Jun. 2, 2005

(54) Moisture-permeable waterproof fabric and method of making the same

(76) Inventor: Zo-Chun Jen, Taipei (TW)

Correspondence Address: STEVENS, DAVIS, MILLER & MOSHER, L.L.P., Suite 850, 1615 L Street, N.W., Washington, DC, 20036, US

(21) Appl. No.: 10/722,404

(22) Filed: Nov. 28, 2003

(51) Int. Cl. B32B 5/02

(52) U.S. Cl. 442/181; 442/59

(57) ABSTRACT

A moisture-permeable waterproof high density fabric made of polyester filament yarn with filament size of 0.2˜0.8 denier per filament (dpf) and with cross section having at least three grooves or recessions formed as Y-shaped, cross-shaped, or W-shaped cross section, or with cross section arranged as distinctive shape of Y-shaped, cross-shaped, or W-shaped cross section at different section of the filament yarn; the fabric is manufactured by high density weaving method, and processed by water repellent and hot press finish after dyeing processing through which to obtain a moisture-permeable waterproof fabric with property of hydrostatic pressure resistance higher than 700 mm H₂O and wash ability better than that of the conventional woven fabric made of polyester filament yarn having round cross section, as well as better reproducibility without the need of coating or laminating processing.

### BACKGROUND OF THE PRESENT INVENTION

1. Field of the Present Invention

The invention relates to a high density moisture-vapor permeable and waterproof fabric, particularly the fabric is made of polyester filament yarn of 0.2˜0.8 dpf and with which cross section is at least formed with three grooves.

2. Description of Prior Act

Conventionally, based on the method of producing a moisture-permeable waterproof fabric can be classified into three types of coating, laminating and high density weaving. An example of coating type was disclosed on Japan Patent Publication No. 10-251976 which concerned an invention embodied by applying continuous or non-continuous coating of chemicals on woven fabric to form a coating film on the surface of the woven fabric. As for the laminating type, known as the transfer coating type, an example was disclosed on Japan Patent Publication No. 2002-030574 which concerned an invention embodied mainly by coating polyurethane (PU) on release paper and than bind the PU film and the fabric together by applying laminating method.

Although these two types of moisture-permeable and waterproof processing can achieve higher hydrostatic pressure resistance and moisture permeability, they still have some drawbacks, for example, the fabric will loss its softness, and increase the hardness due to coating or laminating processing. Also, some of the moisture-permeable waterproof film with microporous layer or film as disclosed in U.S. Pat. Nos. 4,429,000; 4,535,008; and 4,560,611 will be wet with dew under the environment of no humidity difference that causes the film to lose its effect of moisture permeability, or the fabric will crease due to moisture absorption, these drawbacks have caused inconvenience and restriction in the practical use of the fabric.

Conventionally the high density moisture-permeable waterproof fabric is made by using high count filament yarns having round cross section such as 50 d/144f or 75d/144f and applying the specific performance of loom to obtain the highest weaving density of warp and weft yarn and than processed by water repellent and press finish to minimize the gap of weave and enable the effect of moisture permeability and waterproof. Normally the important factors affecting the property of hydrostatic pressure resistance of a fabric are the weaving density of warp and weft yarn of the fabric and the quality of water repellent finish, however since the conventional fine denier filament yarn with round cross section under high weaving density are arranged in an extremely tight condition, it is very difficult for the water repellent to seep into the inner gap between the filaments during water repellent finish that results in the difficulty for the fabric to attain the hydrostatic pressure resistance a level higher than 700 mm H₂O. This is because the water repellent mostly adhere to the filaments on outer surface of the fabric, and are very easy to fall off during washing that decreases the hydrostatic pressure resistance of the fabric. Moreover, since it is pretty hard for the water repellent to seep into inner gap between filaments, the reproducibility is decreased, and the hydrostatic pressure resistance is in a fluctuated condition that causes the fabric unable to attain the requirement of stable quality.

### SUMMARY OF THE PRESENT INVENTION

In view of the above-mentioned drawbacks of being unable to attain the hydrostatic pressure resistance a level higher than 700 mm H₂O and unsatisfied processing stability, it is the major purpose of the invention by high density weaving method to provide a moisture-permeable waterproof fabric made of fine denier polyester filaments with filament size of 0.2˜0.8 dpf and more than three grooves with cross section formed as Y-shaped, W-shaped or cross-shaped on the entire length of the filament or the cross section of the filament yarn is further arranged as distinctive shape at different section of the filament; and then, after completion of water repellent and hot press finish during dyeing finish step, the moisture-permeable waterproof fabric may attain the property of hydrostatic pressure resistance higher than 700 mm H₂O and more stable processing stability.

### BRIEF DESCRIPTION OF THE DRAWING FIGURES

FIG. 1 is shown a kind of three grooves formed on filament yarns of this invention is Y-shaped cross section.

FIG. 2 is shown a kind of four grooves formed on filament yarns of this invention is cross-shaped cross section.

FIG. 3 is shown another kind of four grooves formed on filament yarns of this invention is W-shaped cross section.

### DETAILED DESCRIPTION OF THE PREFERRED EMBODIMENTS

The detail of this invention is further described as follows, there are three principal requirements must be fulfilled for obtaining a moisture-permeable waterproof fabric with good production stability and higher hydrostatic pressure resistance including (a) using fine denier higher count filament; (b) applying high weaving density to reduce the weave-gap to the minimal level; and (c) maintaining good and stable quality of water repellent finish. Among these requirements the key factor determining the stability of quality of the fabric is the quality of water repellent finish.

Take the high count, fine denier polyester filament yarn with round cross section commonly used in the textile industry, theoretically the high tightness between the fibers resulted in by high density weaving should have the effect of providing higher hydrostatic pressure resistance, however practically, since the space between fibers is squeezed to become considerably small, most of the water repellent can only adhere to the fibers on outer surface of the fabric during water repellent finish, and are unable to seep into the inner space between fibers that results in a poor hydrostatic pressure resistance which is below the expected level, or even if a fabric having high hydrostatic pressure resistance could be obtained occasionally, the production quality is always in an unstable condition owing to poor reproducibility or the falling off of the water repellent adhering to the fibers on the outer surface of the fabric during washing.

However, if for the purpose to make it easier for the water repellent to seep into the inner space between fibers the density of the fabric must be decreased, but the negative effect of the reduced density of the fabric will result in the enlarged space between fibers which will result in the insufficient tightness of the fabric though the following hot press finish can slightly increase the tightness of the fibers of the fabric, and the product obtained by this way is still unable to meet the requirement of high hydrostatic pressure resistance.

In the present invention it is better to use high count, fine denier polyester filament yarn as raw material. The reason is for obtaining the optimal arrangement among the two conflicting factors of easy water repellent finish and high density weaving to enable the high density weaving fabric to have the good property for water repellent finish. The cross section of fine denier high count polyester filament yarn used in the present invention has more than three grooves or recessions, or the cross section of the filament yarn is further arranged as distinctive shape at different section of the filament, which has the effect of forming space between filaments that can keep proper gap between the filaments of the high weaving density fabric for the water repellent to seep into the inner side of the yarn easily and uniformly during water repellent finish so as to obtain satisfied quality of water repellent finish, than the high temperature and high pressure of the following press finish can squeeze and eliminate the gap between filaments to obtain satisfied hydrostatic pressure resistance of the fabric. The fine denier high count polyester filament yarn with cross section of at least having three grooves used in the present invention can be of filament or DTY (draw textured yarn) or SDY which is capable of being used as warp or weft yarn or commonly used for both of warp and weft yarn, and shall make up more than 30% of the yarns of the fabric.

If the ratio of the yarn of the fabric made up by the filament with cross section of at least having three grooves is less than 30%, unsatisfied hydrostatic pressure resistance shall be resulted in that will cause the fabric unable to provide the effect proposed by the invention.

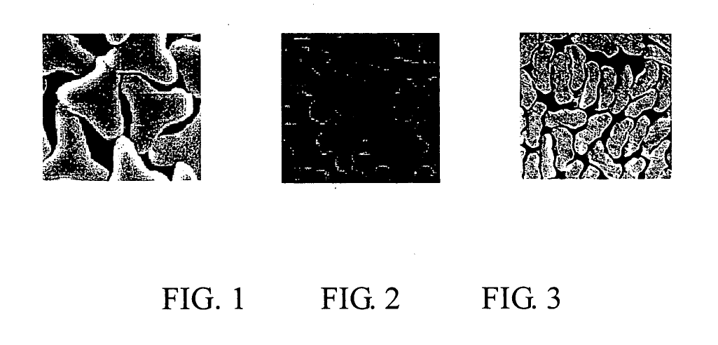

Referring to FIG. 1 to FIG. 3, the cross section of the filament yarn of this present invention may be formed as a Y-shaped cross section having three grooves or recessions; a cross-shaped cross section having four grooves or recessions; or a W-shaped cross section having four grooves or recessions.

However, the scope of the invention is not limited by these three types of cross section though they are proposed here. The grooves on the filament yarn has the effect of avoiding over-tight pile and squeezing between filaments of the fabric under high density weaving and enabling the water repellent more easily to seep into the inner side of the filament yarns under the weaving density same as the fabric made of the filament yarn with round cross section to achieve satisfied production stability and washability of the fabric which has hydrostatic pressure resistance higher than those made of the filament yarns of round cross section to make the filament yarn of the invention the best material for making weave waterproof fabric.

In the following are the descriptions of the analysis and test method of hydrostatic pressure resistance concerning the high density moisture-permeable waterproof woven fabric of the invention:
1. Hydrostatic pressure resistance test
   The test is performed in accordance with Japan Industrial Standards JISL-1092.
   The test's result is expressed in mmH₂O.
2. Washability test:
   The test is performed in accordance with Japan Industrial Standards JISL-0217.

Further in the following is the more detailed description of the invention by examples of embodiment. However the examples proposed here are not to limit the scope of the invention.

### EXAMPLE 1

Use semi-gloss polyester compound as raw material under spinning temperature 290° C. and spinning speed 3000 meter/min through 144-hole Y-shaped cross section spinning jet to make partially oriented yarn (POY) of 125d/144f, the POY than passes the texturing process to obtain the draw textured yarn (DTY) of 75d/144f with Y cross section under filament speed of 600 meter/min.

Use the DTY of 75d/144f with Y cross section as warp and weft yarn through 1/1 plain stitch weaving with warp density of 148 filament yarn/inch and weft density of 108 filament yarn/inch to produce gray fabric which, after scouring and dyeing process, is processed by water repellent finish in five lots with following formula:
Acetic acid 1 ml/l
Ciba INVADINE PBN 5 ml/l
Ciba OLEOPHOBOL 7690 40 g/l
Setting temp.: 170° C.×45 seconds

Then the fabric is processed by KUSTER PRESS at 160° C.×15 yd/min, 100 kg/m², and the analysis of the hydrostatic pressure resistance is carried out after 25 times of washing; and the test results are shown in Table 1

### COMPARISON EXAMPLE 1

Follow the same condition as that of the example I of embodiment except using conventional polyester DTY of 75d/144f with round section. The test results are also shown in Table 1. It shows apparently according to Table 1 that the fabric made of polyester DTY of 75/144 with Y-shaped cross section is better than that of with round cross section whether it is based on hydrostatic pressure resistance or washability or quality stability among different lots.

### EXAMPLE 2

Use polyester DTY of 100d/288f as warp yarn and filament of 75d/96f as weft yarn all of which have cross-shaped cross section, apply 1/1 plain stitch weaving method with warp density of 144 filament yarn/inch and weft density of 112 filament yarn/inch, the gray fabric processed by scouring and dyeing finish and then treated by water repellent finish in five lots with following formula:
Acetic acid 1 ml/l
Ciba INVADINE PEN 5 ml/l
Ciba OLEOPHOBOL 7690 50 g/l
Setting temperature: 170 ° C.×45 seconds

Then the fabric is processed by KUSTER PRESS at 160° C.×15 yd/min, 100 kg/m², and then test and compare the hydrostatic pressure resistance after 25 times of washing. The results are shown in Table 1 which shows apparently that when the polyester DTY with cross-shaped cross section is used as weft yarn, and makes up more than 30% (in this example of embodiment the ratio is 37%) of the yarns of the fabric, a satisfied hydrostatic pressure resistance can still be provided.

### COMPARISON EXAMPLE 2

Use the same conditions as that of Comparison example 1 except using conventional 75d/96f polyester filament with round cross section as weft yarn. The test results are shown in Table 1 which shows that the fabric using polyester filament with round cross section as weft yarn is unable to provide the stable hydrostatic pressure resistance as proposed by the invention.

TABLE 1
Hydrostatic pressure resistance test

| Order of | | | | | | | | | | | |
|---|---|---|---|---|---|---|---|---|---|---|---|
| processing | 1 | | 2 | | 3 | | 4 | | 5 | | |
| 25 times | Before | After | Before | After | Before | After | Before | After | Before | After | |
| washing | washing | washing | washing | washing | washing | washing | washing | washing | washing | washing | result |
| Example 1 | 910 | 800 | 950 | 900 | 900 | 850 | 980 | 860 | 1000 | 950 | good |
| (mmH₂O) | | | | | | | | | | | |
| Comparison 1 | 700 | 520 | 520 | 380 | 750 | 450 | 550 | 400 | 350 | 270 | poor |
| (mmH₂O) | | | | | | | | | | | |
| Example 2 | 1000 | 950 | 1000 | 920 | 1080 | 1010 | 1100 | 1050 | 1050 | 970 | good |
| (mmH₂O) | | | | | | | | | | | |
| Comparison 2 | 780 | 530 | 650 | 500 | 600 | 410 | 700 | 450 | 750 | 550 | poor |
| (mmH₂O) | | | | | | | | | | | |

Order of processing 1-5 is meant that each order of processing includes to have the same fabric been processed 5 times of water repellent and press finish process, and then to test whether the processing stability is good or poor.

The final result is that the hydrostatic pressure resistance test is good for the Example 1 and Example 2 due to the test values shown is stable; but is poor for comparison 1 due to the test values shown in unstable.

1. A method for producing moisture-permeable waterproof fabric comprising
(a) selecting polyester filament yarn with which filament size is 0.2˜0.8 dpf and with which cross section is at least formed with three grooves as row material,;
(b) producing high density fabric by the selected filament yarn; then
(c) by scouring, dyeing, water repellent and press finish process to form a moisture-permeable waterproof fabric with hydrostatic pressure resistance higher than 700 mm H₂O.

2. The method for producing moisture-permeable waterproof fabric as defined in claim 1, wherein the cross section of the selected filament yarn is arranged as distinctive shape at different section of the filament.

3. The method for producing moisture-permeable waterproof fabric as defined in claim 1, wherein the cross section of the selected filament yarn is formed as Y-shaped, cross-shaped or W-shaped cross section.

4. The method for producing moisture-permeable waterproof fabric as defined in claim 2, wherein the cross section at different section of the selected filament yarn is formed as Y-shaped, cross-shaped or W-shaped cross section.

5. The method for producing moisture-permeable waterproof fabric as defined in claim 1, wherein the selected filament yarn includes filament and draw textured yarn.

6. The method for producing moisture-permeable waterproof fabric as defined in claim 2, wherein the selected filament yarn includes filament and draw textured yarn.

7. The method for producing moisture-permeable waterproof fabric as defined in claim 1, wherein the fabric produced includes the selected filament yarn used as warp yarn or weft yarn or used as warp yarn and weft yarn more than 30%.

8. The method for producing moisture-permeable waterproof fabric as defined in claim 2, wherein the fabric produced includes the selected filament yarn used as warp yarn or weft yarn or used as warp yarn and weft yarn more than 30%.

9. A moisture-permeable waterproof fabric has the physical property of hydrostatic pressure resistance higher than 700 mm H20, and comprises more than 30% a kind of polymer filament yarn, as warp yarn or weft yarn or used as warp yarn and weft yarn, with which filament size is 0.2˜0.8 dpf and with which cross section is at least formed with three grooves including formed as Y-shaped, cross-shaped or W-shaped.

10. The moisture-permeable waterproof fabric as defined in claim 9, wherein the cross section of the filament yarn is further arranged as distinctive shape at different section of the filament.
